(19) United States
(12) Patent Application Publication
(10) Pub. No.: US 2004/0108972 A1
(43) Pub. Date: Jun. 10, 2004

(54) Animated display

(76) Inventor: David S. Vogel, New York, NY (US)

Correspondence Address: DAVID VOGEL, 36 EAST 12 TH. STREET, NEW YORK, NY, 10003, US

(21) Appl. No.: 10/314,605

(22) Filed: Dec. 9, 2002

(51) Int. Cl. G09G 3/00

(52) U.S. Cl. 345/32

(57) ABSTRACT

Provided herein are animated display apparatus and methods for producing images on a panel.

### RELATED CASE

This application relates to a co-pending design patent application titled ‘ANIMATED DISPLAY DESIGN’ of the same inventor, David S. Vogel, filed on Dec. 9, 2002 via Express Mail Certificate Number EU 821608252 US, Ser. No. ______, which is hereby specifically incorporated by reference for all that is contained therein.

### BACKGROUND

Various displays have been developed in the past. Some of these displays have been animated, others have been manually operated. Disclosed herein is a novel animated display for creating images on a writing panel.

### SUMMARY

In one exemplary embodiment disclosed herein, an erasable animated display may include: a writing panel comprising a first surface and an oppositely disposed second surface; a magnet selectively interfaced with the first surface; a first axis drive system attached to the first magnet; a preprogrammed path; and wherein the magnet is registered to the preprogrammed path by the first-axis drive system.

### BRIEF DESCRIPTION OF THE DRAWING

Illustrative embodiments are shown in Figures of the Drawing in which:

FIG. 1 shows a perspective view of an exemplary embodiment of an animated display.

FIG. 2 shows a front elevation view of the exemplary animated display of FIG. 1.

FIG. 3 shows a top plan view of the exemplary animated display of FIG. 1.

FIG. 4 shows a side elevation view of the exemplary animated display of FIG. 1.

FIG. 5 shows a perspective view of an exemplary embodiment of an animated display with a housing bottom removed therefrom.

FIG. 6 shows a perspective view of an exemplary embodiment of an animated display with a back removed therefrom.

FIG. 7 shows a perspective view of an exemplary x-axis drive system, y-axis drive system and z-axis drive system.

FIG. 8 shows a back elevation view of the exemplary drive systems illustrated in FIG. 7.

FIG. 9 shows a perspective view on an exemplary carriage provided with exemplary y-axis and z-axis drive systems.

FIG. 10 shows a top plan view of the exemplary carriage illustrated in FIG. 9.

FIG. 11 shows a front elevation view of the exemplary carriage illustrated in FIG. 9.

FIG. 12 shows a side elevation view of the exemplary carriage illustrated in FIG. 9.

FIG. 13 shows a perspective view of an exemplary gantry.

FIG. 14 shows a side elevation view of the exemplary gantry of FIG. 13.

FIG. 15 shows a perspective view of an exemplary x-axis drive system, y-axis drive system and z-axis drive system.

FIG. 16 shows a perspective view of a figure base.

FIG. 17 shows a perspective view of an exemplary animated display with a rectangular drawing thereon.

FIG. 18 shows a perspective view of an exemplary animated display with a drawing formed thereon.

FIG. 19 shows a front elevation view of an exemplary animated display without any drawing thereon.

FIG. 20 shows a front elevation view of an exemplary animated display at the outset of the forming of an exemplary drawing.

FIG. 21 shows a front elevation view of an exemplary animated display at the completion of the forming of an exemplary drawing.

FIG. 22 shows a front elevation view of an exemplary animated display near the completion of an erasing process.

### DETAILED DESCRIPTION

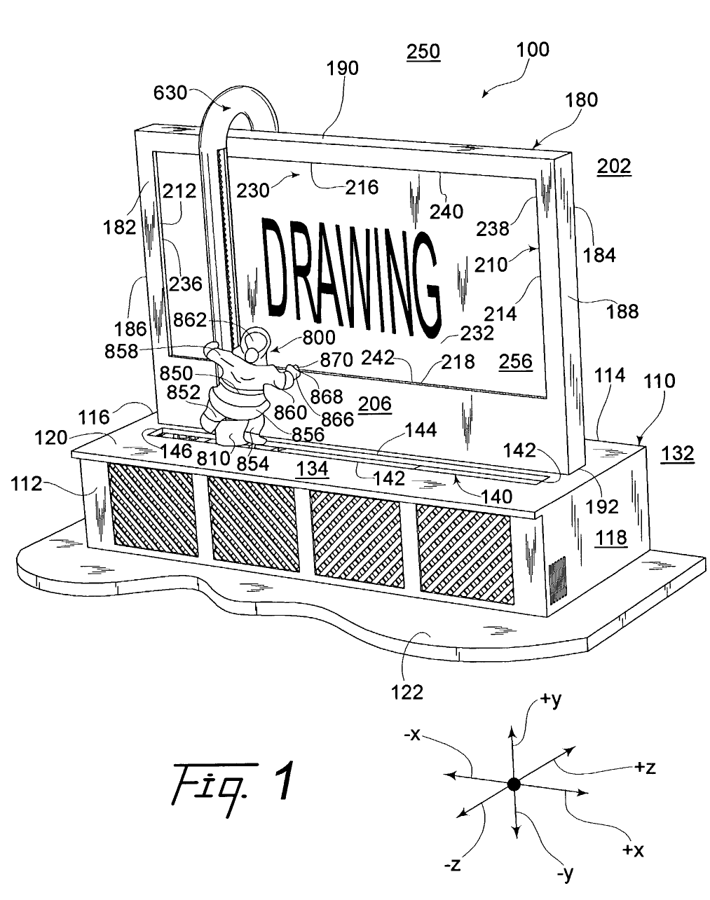

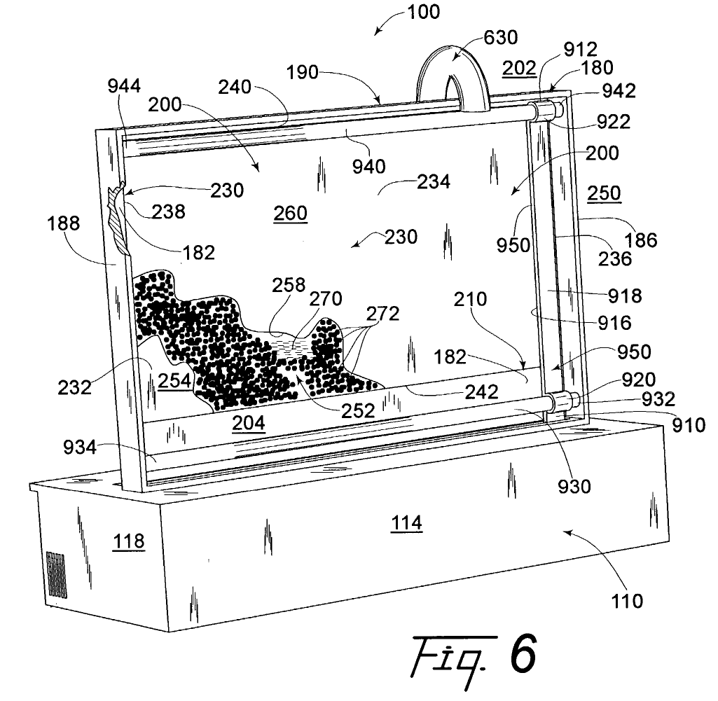

FIGS. 1-4 illustrate one exemplary embodiment of an animated display 100. The animated display 100 may be provided with a housing 110, a billboard 180, a gantry 630, a figure 800 and a controller 1050 (FIG. 5). In general terms, the figure 800 may be controlled by the controller 1050 to move thereby forming an image on the billboard 180.

With reference to FIG. 1, the animated display hosing 110 may be provided with a front 112, a back 114, a left side 116, a right side 118, a top 120 and a bottom 122.

It is to be understood that terms such as ‘front’, ‘back’, ‘top’, ‘bottom’, ‘horizontal’, ‘vertical’ and the like are used herein for illustrative purposes only. In actual use, the animated display 100 (and components thereof) can be configured in almost any orientation, thus making terms such as ‘front’, ‘back’, ‘top’, ‘bottom’, ‘horizontal’ and ‘vertical’ relative to the orientation of the animated display.

With continued reference to FIG. 1, the housing front 112 may be oppositely disposed from the back 114. The housing left side 116 may be oppositely disposed from the right side 118. Additionally, the housing top 120 may be oppositely disposed from the bottom 122. The housing 110 may define an interior portion 130 (FIG. 5) and an exterior portion 132. The housing front 112, back 114, left side 116, right side 118, top 120 and bottom 122 may be formed in a somewhat parallelepiped configuration separating housing interior portion 130 from the exterior portion 132. The housing top 120 may be provided with an external surface 134 and an oppositely disposed internal surface 136 (FIG. 5). The housing top external surface 134 may be adjacent to the housing external portion 132. The housing top internal surface 136 may be adjacent to the housing internal portion 130 (FIG. 5). Additionally, in one exemplary embodiment, the housing bottom 122 may be removably attached to the housing front 112, back 114, left side 116 and right side 118 (e.g. by being fastened together by a plurality of screws, not shown).

With reference to FIG. 3, the housing 110 may be further provided with a front slot 140 and a back slot 150. The front slot 140 may be formed in the housing top 120 providing passage between the housing interior portion 130 and the housing exterior portion 132. The front slot 140 may be formed somewhat near the housing front 112. The front slot 140 may be provided with a front 142, a back 144, a left side 146 and a right side 148. The front slot front 142 may be oppositely disposed from the front slot back 144. Additionally, the front slot left side 146 may be oppositely disposed from the right side 148. Additionally, the housing front slot front 142 and back 144 may be substantially parallel to each other and also parallel to the housing front 112 and back 114.

With reference to FIG. 5, the back slot 150 may be formed in the housing top 120 providing passage between the housing interior portion 130 and the housing exterior portion 132. The back slot 150 may be formed somewhat near the housing back 114. The back slot 150 may be provided with a front 152, a back 154, a left side 156 and a right side 158. The back slot front 152 may be oppositely disposed from the back 154. Additionally, the back slot left side 156 may be oppositely disposed from the right side 158. The housing back slot front 152 and back 154 may be substantially parallel to each other and also parallel to the housing front 112 and back 114.

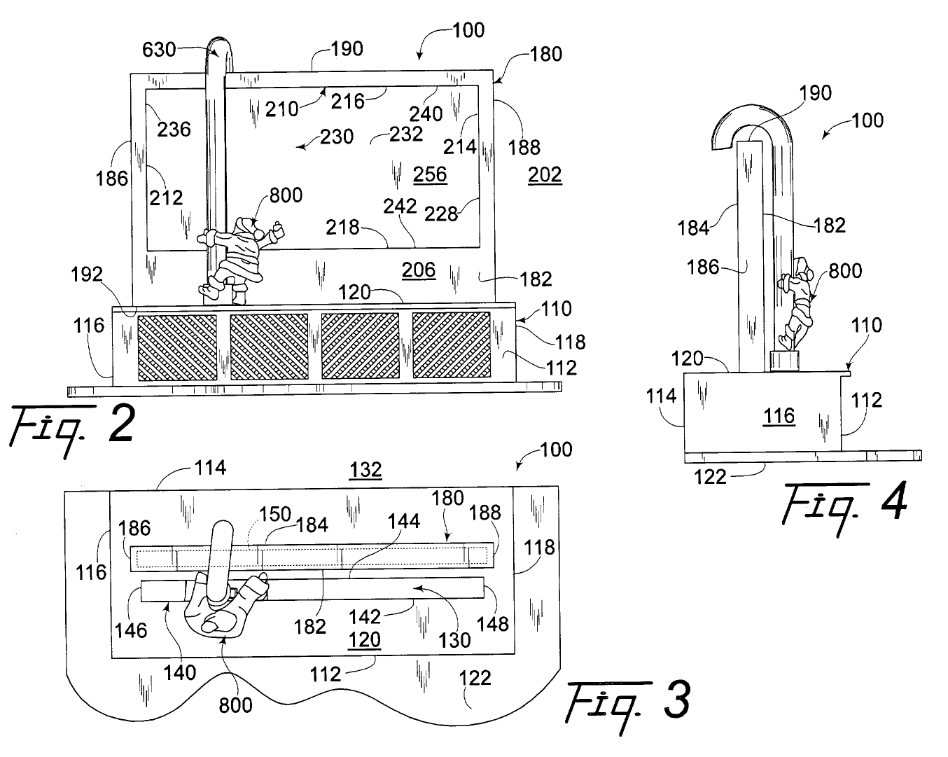

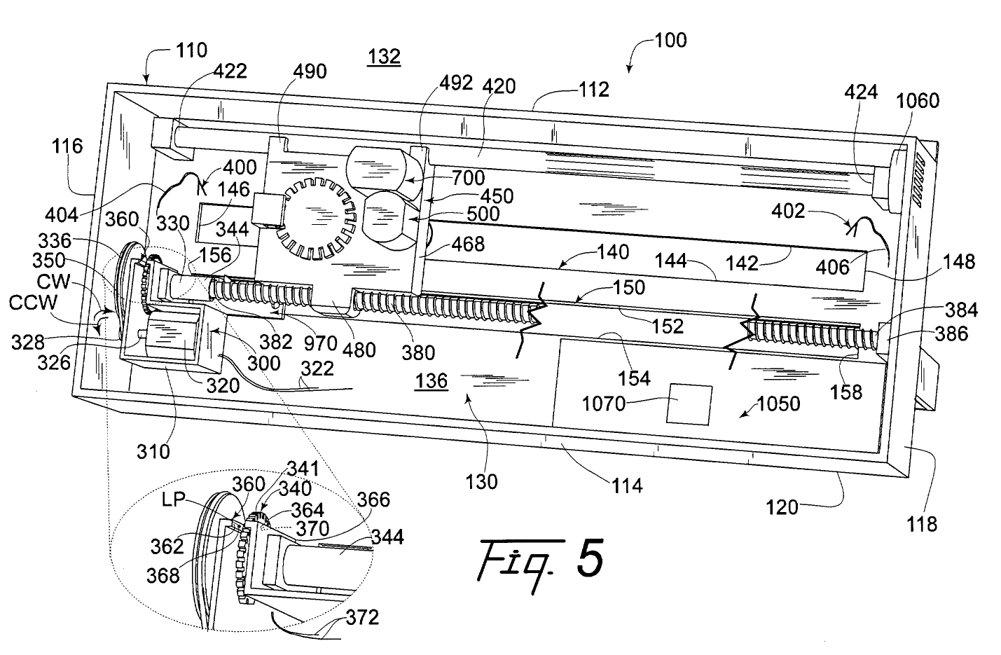

With reference to FIG. 2, the animated display 100 may also be provided with a billboard 180. The billboard 180 may be provided with a front 182, a back 184 (FIG. 4), a left side 186, a right side 188, a top 190 and a bottom 192. The billboard front 182 may be oppositely disposed from the back 184. The billboard left side 186 may be oppositely disposed from the right side 188. The billboard top 190 may be oppositely disposed from the bottom 192. The billboard 180 may define an interior portion 200 (FIG. 6) and an exterior portion 202. The billboard front 182, back 184, left side 186, right side 188, top 190 and bottom 192 may be configured in a substantially parallelepiped configuration separating the billboard interior portion 200 (FIG. 6) from the exterior portion 202. The billboard front 182 may be provided with an internal surface 204 (FIG. 6) and an external surface 206. The billboard front internal surface 204 may be oppositely disposed from the external surface 206. The billboard front internal surface 204 (FIG. 6) may be adjacent to the interior portion 200 (FIG. 6); and, the billboard front external surface 206 may be adjacent to the exterior portion 202. Additionally, the billboard back 184 may be removably attached to the left side 186, right side 188, top 190 and bottom 192 by fasteners (not shown) to provided access to the billboard interior portion 200.

With continued reference to FIG. 2, the animated display billboard 180 may be further provided with a window 210. The window 210 may be formed in the billboard front 182. The window 210 may extend between the front internal surface 204 (FIG. 2) and the external surface 206 thereby providing passage between the interior portion 200 and the exterior portion 202. The window 210 may be provided with a left side 212, a right side 214, a top 216 and a bottom 218. The window left side 212, right side 214, top 216 and bottom 218 may be formed in a somewhat quadrilateral configuration. With this quadrilateral configuration, the window left and right sides 212, 214 may be parallel to each other and also parallel to the billboard left and right sides 186, 188. Additionally, the billboard window top 216 and bottom 218 may be formed somewhat parallel to each other and also parallel to the billboard top 190 and bottom 192.

With reference to FIG. 6 showing a back elevation view of the animated display billboard 180, the billboard 180 may be further provided with a writing panel 230. The writing panel 230 may be provided with a front 232, a back 234, a left side 236, a right side 238, a top 240 and a bottom 242. The writing panel front 232, back 234, left side 236, right side 238, top 240 and bottom 242 may be formed in a somewhat parallelepiped configuration defining an external portion 250 and an internal portion 252. The writing panel front 232 may be provided with an internal surface 254 and an external surface 256 (FIG. 2). The internal surface 254 may be oppositely disposed from the external surface 256; the internal surface 254 may also be adjacent to the internal portion 252. The writing panel front external surface 256 (FIG. 2) may be adjacent to the external portion 250.

With continued reference to FIG. 6, the writing panel back 234 may be provided with an internal surface 258 and an external surface 260. The internal surface 258 may be oppositely disposed from the external surface 260; the internal surface 258 may also be adjacent to the internal portion 252. The writing panel back external surface 260 may be adjacent to the external portion 250.

In one exemplary embodiment, the writing panel 230 may be of the type sometimes referred to as an ‘electrophoretic’ display. As used herein, the term electrophoretic may define any type of display operating under the premise of electrophoresis. Electrophoresis is the movement of suspended particles through a fluid or gel under the action of an electromotive force. The writing panel 230 may be provided with a liquid 270 configured between the front internal surface 254 and the back internal surface 258. This liquid 270 may have a relatively large quantity of particles 272 suspended therein. In a manner that will be described in detail later herein, the application of electromotive force (e.g. a magnet) to a containment vessel (e.g. the writing panel 230) causes the suspended particles 272 (e.g. iron particles) to move towards the point where the electromotive force is applied. This application of electromotive force may result in visible ‘writing’ on the vessel containing the liquid (e.g. drawing on the writing panel front 232). It should be noted that this ‘writing’ may be erased by applying a second electromotive force to bring the suspended particles 272 away from the front 232 and towards the back 234.

With reference to FIG. 2, the writing panel 230 may be attached to the billboard 180 such that the majority of the writing panel 230 spans the billboard window 210. This attachment of the writing panel 230 to the billboard 180 may be provided by a plurality of fasteners such as, for example, screws (not shown). With this exemplary configuration, the writing panel front 232 may be coplanar with (or, alternatively slightly offset from) the billboard front 182. Additionally, the writing panel top 240 may be substantially parallel and adjacent to the billboard window top 216. The writing panel bottom 242 may be substantially parallel and adjacent to the billboard window bottom 242. The writing panel left side 236 may be substantially parallel and adjacent to the billboard window left side 212. The writing panel right side 238 may be substantially parallel and adjacent to the billboard window right side 214.

With continued reference to FIG. 2, the billboard 180 may be attached to the housing 110. This attachment may be provided by a plurality of screws (not shown), or, alternatively, the billboard 180 may be integrally formed with the housing 110. The billboard bottom 192 may be adjoining the housing top 120 somewhere between the front slot 140 (FIG. 3) and the housing back 114 (FIG. 4). This attachment may also result in the billboard front 182 being parallel to and offset from the housing front 112. The billboard left side 186 may be parallel to and offset from the housing left side 116. The billboard right side 188 may be parallel to and offset from the housing right side 118.

With reference to FIG. 5 illustrating a perspective view of the housing 110 with the bottom 122 removed therefrom, the animated display 100 may be provided with an x-axis drive system 300. The x-axis drive system 300 may be positioned within the housing interior portion 130. The x-axis drive system 300 may be provided with a housing 310. The x-axis drive system housing 310 may be mounted to the animated display housing 110, or, alternatively, the x-axis drive system housing 310 may be integrally formed on the housing 110.

With continued reference to FIG. 5, the x-axis drive system 300 may be provided with a motor 320, a drive shaft 330 and a threaded rod 380. The motor 320 may be a conventional DC-type motor provided with a pair of leads 322 and an output shaft 326. Application of electricity to the leads 322 causes rotation of the output shaft 326. Depending on the polarity (positive or negative) of the electricity applied to the leads 322, the output shaft 326 rotates in a clockwise direction denoted as ‘CW’ or counter clockwise direction denoted as ‘CCW’. The X-axis drive system 300 may be provided with a first pulley 328. The first pulley 328 may be fixedly attached to the motor output shaft 326. Furthermore, the x-axis motor leads 322 may be electrically interfaced with the controller 1050.

With reference to FIG. 7 illustrating a perspective view of several components including the x-axis drive system 300 removed from the housing 110, the x-axis drive system drive shaft 330 may be provided with a first end 332 and a second end 334. The first end 332 may be oppositely disposed from the second end 334. The drive shaft 330 may be further provided with a second pulley 336, a first bushing 338, a disk 340, a second bushing 342 and a coupler 344. The second pulley 336, first bushing 338, disk 340, second bushing 342 and coupler 344 may be positioned on the drive shaft 330. The second pulley 336 may be fixedly attached to the drive shaft first end 332. The first bushing 338 may be positioned on the drive shaft 330 somewhat axially offset from the second pulley 336 to rotationally support the drive shaft 330. The disk 340 may be fixedly attached to the drive shaft at a point somewhat offset from the first bushing 338. Additionally, the disk 340 may have a plurality of graduations 341 (FIG. 5) formed therein. The second bushing 342 may be positioned on the drive shaft 330 somewhat axially offset from the disk 340 to rotationally support the drive shaft 330. The coupler 344 may be fixedly attached to the drive shaft 330 at a point somewhat axially offset from the second bushing 342. With reference to FIG. 5, the drive shaft 330 may be rotationally coupled to the motor output shaft 326 via a belt 350 interfaced with the first and second pulleys 328, 336.

With continued reference to FIG. 5, the X-axis drive system 300 may be further provided with a gate 360. The gate 360 may be of the type commonly referred to as an optical gate. If the gate 360 is of the optical type, the gate 360 may be provided with a first leg 362, a second leg 364 and a base 366. The base 366 may be attached to the x-axis drive system housing 310, or, alternatively, integrally formed therewith. The first and second legs 362, 364 may be formed such that they protrude from the base 366. The first and second legs 362, 364 may be oppositely disposed from each other such that they reside on opposite sides of the disk 340. One of the legs (e.g. first leg 362) may be provided with a light source 368. The other leg (e.g. second leg 364) may be provided with a light receiver 370. Light may travel from the light source 368 to the light receiver 370 along a light path denoted as ‘LP’. The gate 360 may be further provided with a leads 372 for reporting the status of light traveling along the light path LP. In a manner that will be described later herein, the disk graduations 341 may block light generated by the light source 368 from traveling to the light receiver 370.

With continued reference to FIG. 5, the x-axis drive system 300 may be further provided with the threaded rod 380. The threaded rod 380 may be provided with a first end 382 and an oppositely disposed second end 384. The threaded rod first end 382 may be engaged to the drive shaft 330 via the coupler 344. The threaded rod second end 384 may be rotationally supported by the housing 110 via a third bushing 386.

With continued reference to FIG. 5, the x-axis drive system 300 may be further provided with a first limit switch 400 and a second limit switch 402. The first limit switch 400 may be fixedly attached to the housing 110 somewhat near the housing left side 116. The second limit switch 402 may be fixedly attached to the housing 100 somewhat near the housing right side 118. The first limit switch 400 may be provided with a pair of leads 404. The second limit switch 402 may be provided with a pair of leads 406. These leads 404, 406 may be attached to the controller 1050. These x-axis drive system limit switches 400, 402 may be utilized for monitoring that the x-axis drive system 300 operates in an intended travel range.

With continued reference to FIG. 5, the x-axis drive system 300 may be further provided with a guide rod 420. The guide rod 420 may be provided with a first end 422 and an oppositely disposed second end 424. The guide rod ends 422 and 424 may be fixedly attached to the housing 110. Additionally, the guide rod 420 may be positioned substantially parallel to the x-axis drive system threaded rod 380. Therefore, the guide rod 420 may be substantially parallel to the front and back slots 140, 150 (FIGS. 1 and 5, respectively).

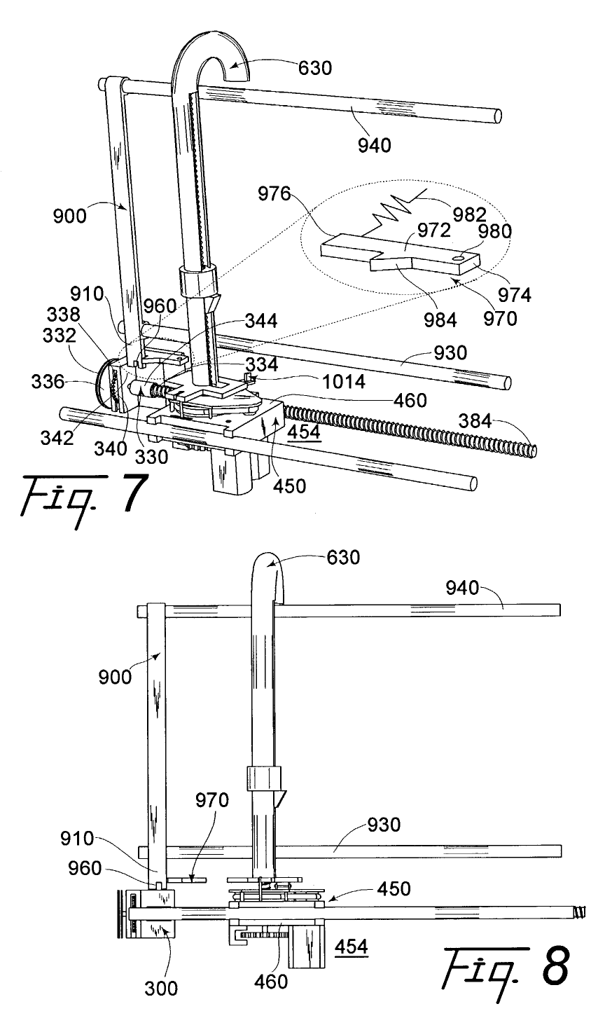

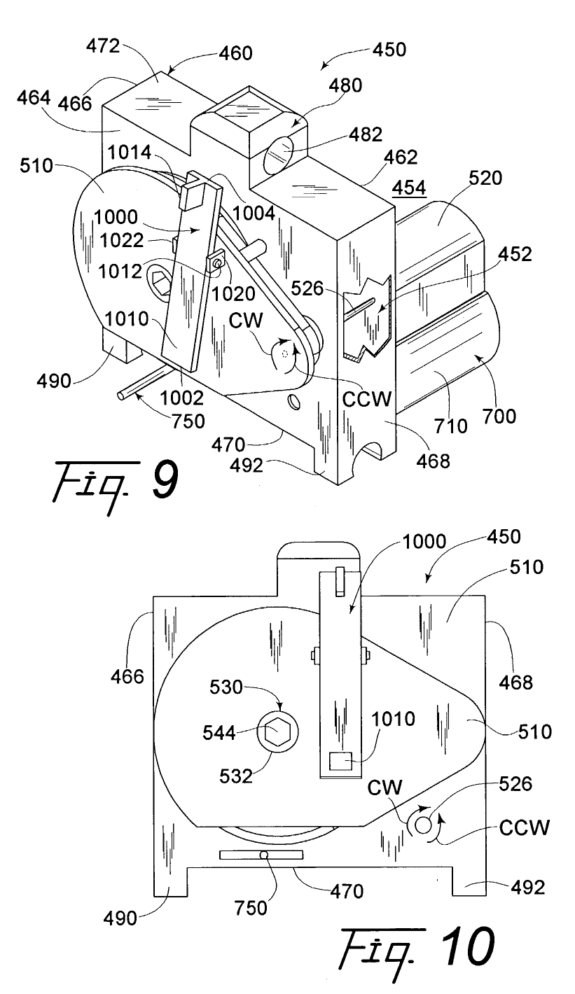

With reference to FIGS. 7 and 8, the animated display 100 may be further provided with a carriage 450. The carriage 450 may comprise a housing 460 that substantially separates an internal portion 452 (FIG. 9) from an external portion 454. With reference to FIG. 9 illustrating a perspective view of the carriage 450, the carriage housing 460 may be provided with a top 462, a bottom 464, a left side 466, a right side 468, a front 470 and a back 472. The housing top 462, bottom 464, left side 466, right side 468, front 470 and back 472 may be formed in a somewhat parallelepiped configuration that substantially separates the internal portion 452 from the external portion 454.

With continued reference to FIG. 9, the carriage 450 may be provided with a nut 480. The nut 480 may be formed on the carriage housing back 472. The nut 480 may be provided with a threaded hole 482 that may be engaged with the x-axis drive system threaded rod 380 (FIG. 5).

With reference to FIG. 10 illustrating a bottom plan view of the carriage 450, the carriage 450 may also be provided with a first guide 490 and a second guide 492. The first guide 490 may be formed on the carriage housing front 470 somewhat near the carriage housing left side 466. The second guide 492 may be formed on the carriage housing front 470 somewhat near the carriage housing right side 468. As illustrated in FIG. 5, the first and second guides 490, 492 may engage the x-axis drive system guide rod 420 for supporting the carriage 450 as it moves in a manner that will be described later herein.

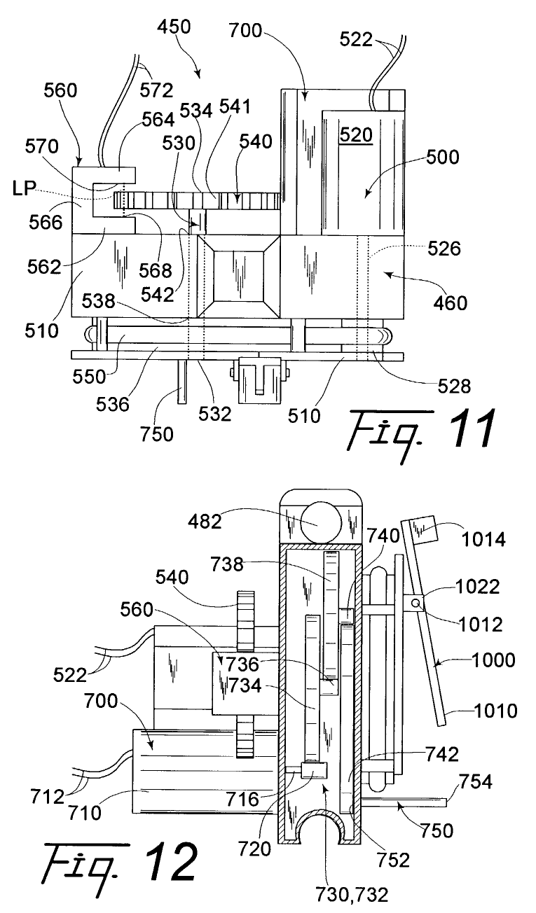

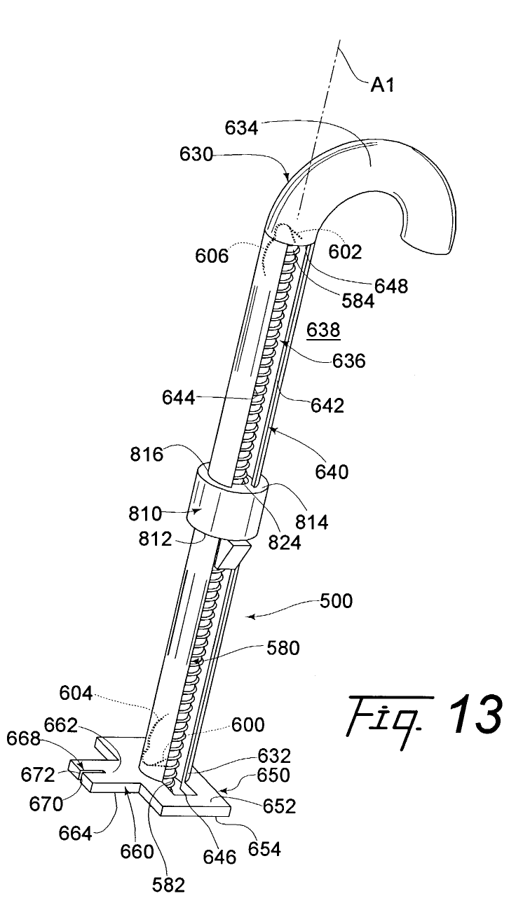

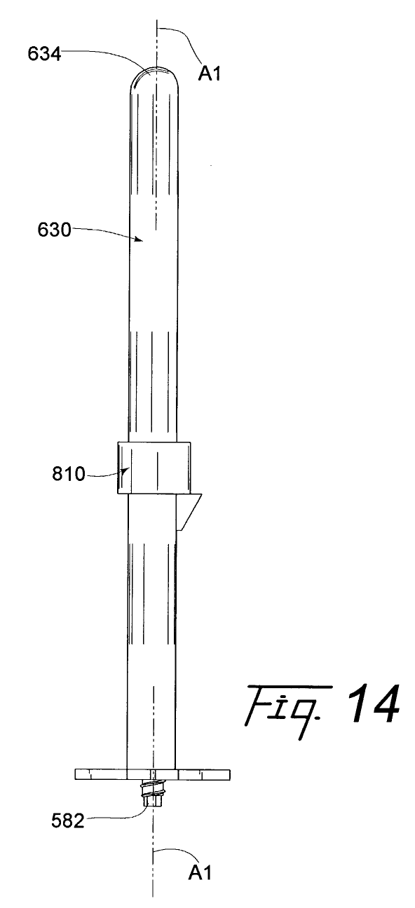

With reference to FIG. 11, the carriage 450 may be provided with a y-axis drive system 500. The y-axis drive system 500 may be provided with a housing 510. The y-axis drive system housing 510 may be mounted on the carriage 450, or, alternatively, the y-axis drive system housing 510 may be integrally formed with the carriage housing 460. The y-axis drive system 500 may be further provided with a motor 520, a drive shaft 530 and a threaded rod 580 (FIG. 13). The motor 520 may be a conventional DC-type motor provided with a pair of leads 522 and an output shaft 526. Application of electricity to the leads 522 may cause rotation of the output shaft 526. Depending on the polarity (positive or negative) of the electricity applied to the leads 522, the output shaft 526 rotates in a clockwise direction denoted as ‘CW’ (FIG. 9) or counter clockwise direction denoted as ‘CCW’ (FIG. 9). The y-axis drive system 500 may be further provided with a first pulley 528. The first pulley 528 may be fixedly attached to the motor output shaft 526.

With continued reference to FIG. 11, the y-axis drive system drive shaft 530 may be provided with a first end 532 and a second end 534. The first end 532 may be oppositely disposed from the second end 534. The drive shaft 530 may be further provided with a second pulley 536, a first bushing 538, a disk 540, a second bushing 542 and a coupler 544 (FIG. 10). The second pulley 536, first bushing 538, disk 540 and second bushing 542 may be positioned on the drive shaft 530. The second pulley 536 may be fixedly attached to the drive shaft first end 532. Additionally, the second pulley 536 may be provided with the coupler 544 (FIG. 10) integrally formed therewith. The first bushing 538 may be positioned on the drive shaft 530 somewhat linearly offset from the second pulley 536 to rotationally support the drive shaft 530. The disk 540 may be fixedly attached to the drive shaft 530 at the second end 534. Additionally, the disk 540 may have a plurality of graduations 541 formed therein. The second bushing 542 may be positioned on the drive shaft 530 somewhat linearly offset from the disk 340 to rotationally support the drive shaft 530. The drive shaft 530 may be rotationally coupled to the motor output shaft 526 via a belt 550 positioned around the first and second pulleys 528, 536.

With continued reference to FIG. 11, the y-axis drive system 500 may be further provided with a gate 560. The gate 560 may be of the type commonly referred to as an optical gate. If the gate 560 is an optical gate, the gate 560 may be provided with a first leg 562, a second leg 564 and a base 566. The first leg 562 may be attached to the y-axis drive system housing 510. The first and second legs 562, 564 may be formed such that they protrude from the base 566. The first and second legs 562, 564 may be oppositely disposed from each other such that they reside on opposite sides of the disk 540. One of the legs (e.g. first leg 562) may be provided with a light source 568. The other leg (e.g. second leg 564) may be provided with a light receiver 570. Light may travel from the light source 568 to the light receiver 570 along a light path denoted as ‘LP’. The gate 560 may be further provided with a leads 572 for reporting the status of light traveling along the light path LP. In a manner that will be described later herein, the disk graduations 541 may block light generated by the light source 568 from traveling to the light receiver 570.

With reference to FIG. 13, the y-axis drive system 500 may be further provided with the threaded rod 580. The threaded rod 580 may be provided with a first end 582 and an oppositely disposed second end 584. The threaded rod first end 582 may be engaged to the drive shaft 530 via the coupler 544 (FIG. 10).

With continued reference to FIG. 13, the y-axis drive system 500 may be further provided with a first limit switch 600 and a second limit switch 602. Positioning of the first limit switch 600 and the second limit switch 602 will be described later herein after a gantry 630 has been described. The first limit switch 600 may be provided with a pair of leads 604. The second limit switch 602 may be provided with a pair of leads 606. These leads 604, 606 may be attached to the controller 1050. These y-axis drive system limit switches 600, 602 may be utilized for monitoring that the y-axis drive system 500 operates in an intended travel range as will be described in detail later herein.

With reference to FIG. 13, the animated display 100 (FIG. 1) may be provided with the gantry 630. Although gantry 630 is illustrated as a cane with a curved top, it is to be understood that the gantry 630 may take any of a variety of forms. The gantry 630 may be provided with a first end 632 and an oppositely disposed second end 634. The gantry 630 may be formed with a somewhat ‘hollow’ configuration wherein an internal portion 636 may be separated from an external portion 638. The gantry 630 may be provided with a window 640 providing communication between the gantry internal portion 636 and the external portion 638. The window 640 may be provided with a first surface 642, as second surface 644, a first end 646 and a second end 648. The window first surface 642 may be parallel to and oppositely disposed from the second surface 646. The first end 646 may be formed between the first and second surfaces 644, 646 and somewhat near the first end 632. The second end 648 may be formed between the first and second surfaces 644, 648 and somewhat near the second end 634.

With continued reference to FIG. 13, the gantry 630 may be provided with a base 650. The base 650 may be attached to, or, alternatively, integrally formed on the base first end 652. The base 650 may be provided with a first surface 652 and an oppositely disposed second surface 654. The base 650 may be further provided with a fork 660. The fork 660 may be provided with a first surface 662 and an oppositely disposed second surface 664. The fork first surface 662 may be formed on the base second surface 654. The fork 660 may be provided with a slot 668. The slot 668 may be provided with a first surface 670 and an oppositely disposed second surface 672.

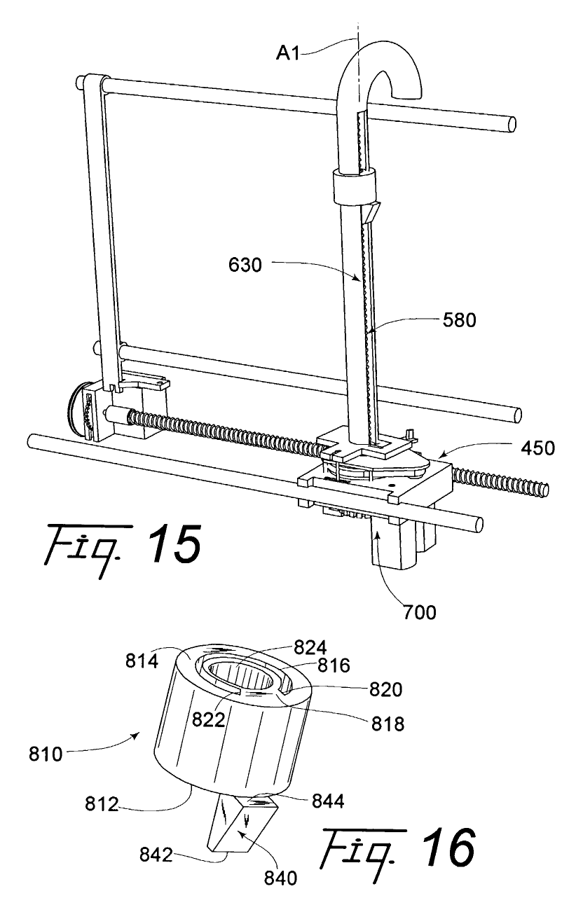

With reference to FIG. 15, the gantry 630 may be pivotally attached to the carriage 450. This pivotal attachment may allow the gantry 630 to be rotated about a first axis A1. As described later herein, this rotation may occur through the application of force to the fork first surface 670 (FIG. 13) or the fork second surface 672 (FIG. 13).

With reference to FIG. 15, the gantry 630 may be pivoted about the first axis A1 by a z-axis drive system 700. With reference to FIG. 12 illustrating a side elevation view of the carriage 450 with the right side 468 removed therefrom, the z-axis drive system 700 may be provided with a motor 710. The motor 710 may be a conventional DC-type motor provided with a pair of leads 712 and an output shaft 716. Application of electricity to the leads 712 may cause rotation of the output shaft 716. Depending on the polarity (positive or negative) of the electricity applied to the leads 712, the output shaft 716 rotates in a clockwise direction denoted as ‘CW’ (FIG. 10) or counter clockwise direction denoted as ‘CCW’ (FIG. 10). The z-axis drive system 700 may be further provided with a first gear 720. The first gear 720 may be fixedly attached to the motor output shaft 716. The z-axis drive system 700 may be further provided with a transmission 730. The transmission 730 may be provided for increasing the torque generated by the motor 710 to be used to rotated the gantry 630 about the first axis A1. The transmission 730 may, for example, increase this torque through a plurality of gears 732. The plurality of gears 732 may, for example, include a second gear 734, a third gear 736, a fourth gear 738, a fifth gear 740 and a sixth gear 742. Although the transmission 730 may take any of a number of configurations, in one exemplary configuration the second gear 734 may be integrally formed with the third gear 736. The second gear 734 may be gearingly interfaced with the first gear 720. Additionally, the fourth gear 738 may be integrally formed with the fifth gear 740. The fourth gear 738 may be gearingly interfaced with the third gear 736. Additionally, the sixth gear 742 may be gearingly interfaced with the fifth gear 740. The z-axis drive system 700 may be provided with a lever 750. The lever 750 may be provided with a first end 752 and an oppositely disposed second end 754. The lever first end 752 may be formed on the sixth gear 742. This z-axis drive system lever 750 may be provided for rotating the gantry 630 (FIG. 15) about the first axis A1 in a manner that will be described later herein. It should be noted that this gantry 630 movement may be provided via the z-axis drive system lever 750 acting upon the gantry fork 660 (FIG. 13).

With reference to FIG. 1, the animated display 100 may be further provided with a figure 800. The figure 800 may take any of a variety of forms such as, for example, Santa, a skier, a surfer, a skateboarder, an airplane, a boat, a witch on a broomstick, a ghost, a vampire, a dog, a puppy, a cat, a cow, a pig, a racecar, a tractor, a bus, or any one of a limitless number of other objects.

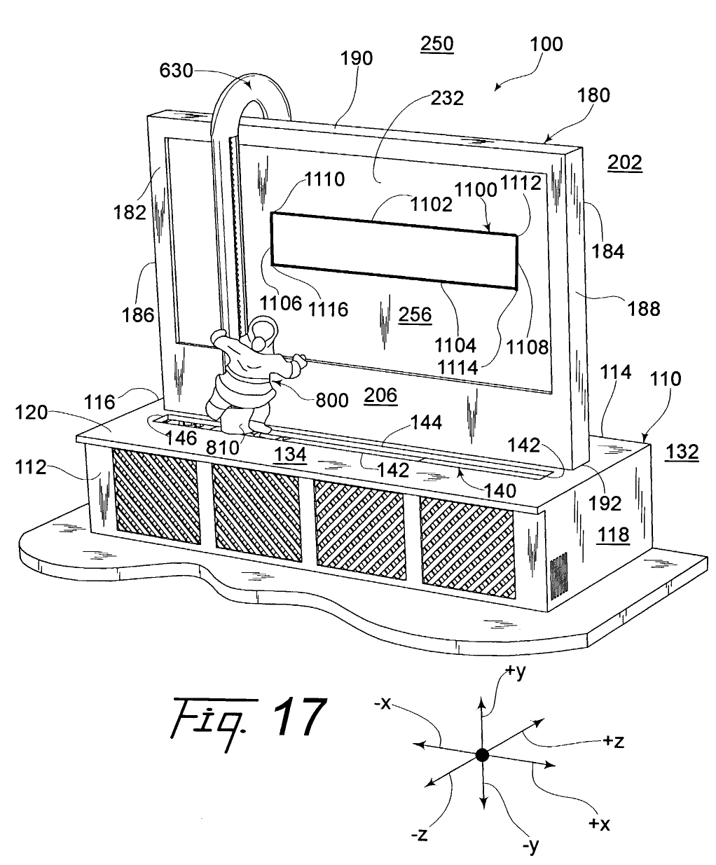

As illustrated in FIG. 1, in one exemplary embodiment, the figure 800 may take the form of Santa. The figure 800 may be provided with a base 810. With reference to FIG. 16 illustrating the figure base 810 with the figure 800 removed therefrom, the figure base 810 may be provided with a first end 812 and an oppositely disposed second end 814. The base 810 may be further provided with a first hole 816 formed between the first and second ends 812, 814. The first hole 816 may be formed with a key 818. The first hole key 818 may be provide with a first surface 820 and an oppositely disposed second surface 822. The base 810 may be further provided with a second hole 824. The second hole 824 may be formed in the base 810. The second hole 824 may be formed as a threaded nut that may be interfaced with the y-axis drive system threaded rod 580 (FIG. 15). With reference to FIG. 13, the figure base 810 may be interfaced with the gantry 630 and the y-axis drive system threaded rod 580. This interfacing may result in the base first hole 816 being slidingly engaged with the gantry 630. Therefore, the figure base first hole key 818 may travel in the gantry window 640. This interfacing may result in the rotation of the gantry 630 being mirrored by the figure 800. Additionally, the figure base second hole 824 may be threadingly engaged with the y-axis drive system threaded rod 580. Rotation of the threaded rod 580 may result in movement of the figure 800 with respect to the gantry 930.

With reference to FIG. 16, the figure base 810 may be further provided with a lever 840. The lever 840 may be provided with a first end 842 and an oppositely disposed second end 844. The lever first end 842 may extend a distance from the figure base first end 812.

With reference to FIG. 1, the figure 800 may be further provided with a body 850. The body 850 may take a human form, or, alternatively may be any of a number of objects (such as those previously described). When taking a human form (e.g. Santa), the body 850 may be provided with a left leg 852, a right leg 854, a torso 856, a left arm 858, a right arm 860 and a head 862. The left leg 852, right leg 854, left arm 858, right arm 860 and head 862 may be attached to the torso 856 as illustrated. The right arm 860 may be provided with a hand 866, a brush 868 and a magnet 870. The hand 866 may be formed on the right arm 860. The brush 868 may be formed on the hand 866. The magnet 870 may be formed on the brush 868. This magnet 870 may take the form of a permanent magnet, or, alternatively, an electromagnet. The figure body left and right legs 852,854 may be fixedly attached to the base 810. Therefore, the magnet 870 may be attached to the carriage 450 via the x-axis, y-axis and z-axis drive systems 300, 500, 700, respectively.

With reference to FIG. 6, the animated display 100 may be further provided with an eraser 900. The eraser 900 may be provided with a first end 910 and an oppositely disposed second end 912. Additionally, the eraser 900 may be provided with a first surface 916 and an oppositely disposed second surface 918. The eraser 900 may be further provided with a first gib 920 and a second gib 922. The first gib 920 may be formed on the eraser second surface 918 somewhat near the first end 910. The second gib 922 may be formed on the eraser second surface 918 somewhat near the second end 912. The eraser 900 may also be provided with a second guide rod 930. The eraser second guide rod 930 may be provided with a first end 932 and an oppositely disposed second end 934. In one exemplary embodiment, the eraser second guide rod 930 may be a somewhat cylindrical stanchion suspended by the second guide rod first and second ends 932, 934. The second guide rod first end 932 may be supported by the billboard left side 186; the second guide rod second end 934 may be supported by the billboard right side 188. The second guide rod 930 may receive the eraser first gib 920. The eraser 900 may also be provided with a third guide rod 940. The eraser third guide rod 940 may be provided with a first end 942 and an oppositely disposed second end 944. In one exemplary embodiment, the eraser third guide rod 940 may be a somewhat cylindrical stanchion suspended by the third guide rod first and second ends 942, 944. The third guide rod first end 942 may be supported by the billboard left side 186; the third guide rod second end 944 may be supported by the billboard right side 188. The third guide rod 940 may receive the eraser second gib 922. The eraser 900 may be provided with a magnet 950. The magnet 950 may be a permanent magnet sometimes referred to as a ‘strip magnet’. The eraser magnet 950 may be permanently attached to the eraser first surface 916.

With reference to FIG. 7, the eraser 900 may be further provided with a catch 960. The catch 960 may be formed in the eraser first end 910. Additionally, the eraser 900 may be provided with a retaining latch 970. The retaining latch 970 may be provided with a base 972. The retaining latch base 972 may be provided with a first end 974 and an oppositely disposed second end 976. The retaining latch 970 may be further provided with a pivot 980, a spring 982 and a ramp 984. The pivot 980 may be formed in the retaining latch base 972 somewhat near the first end 374. The spring 982 may be biasingly interfaced with the retaining latch 970 somewhat oppositely disposed from the pivot 980. The ramp 984 may be formed on the retaining latch base 972 somewhat between the first and second ends 974, 976. As illustrated in FIG. 5, in one exemplary embodiment, the retaining latch 970 may be pivotally attached to the animated display housing 110 somewhat near the back slot left side 156. The retaining latch 970 may selectively secure the eraser 900 near the back slot left side 156. This process may also be referred to herein as selectably coupling the eraser 900 to the carriage 450.

With reference to FIG. 9, the carriage 450 may be further provided with an eraser actuator 1000. The eraser actuator 1000 may be provided with a first end 1002 and an oppositely disposed second end 1004. The eraser actuator 1000 may be further provided with a contact patch 1010, a pivot 1012 and a protrusion 1014. The contact patch 1010 may be located somewhat near the eraser actuator first end 1002. The pivot 1012 may be formed somewhat between the eraser actuator first and second ends 1002, 1004. The protrusion 1014 may be formed somewhat near the eraser actuator second end 1004. As illustrated in FIG. 9, the eraser actuator 1000 may be pivotally attached to the carriage 450 by a first protrusion 1020 and a second protrusions 1022. When assembled, the eraser actuator protrusion 1014 may selectively engage the eraser catch 960 (FIG. 7). When engaged via the eraser actuator 1000, movement of the carriage 450 may cause movement of the eraser 900. As will be described later herein, the eraser actuator 1000 may be activated by the figure 800.

With reference to FIG. 5, the animated display 100 may be provided with a controller 1050. The controller 1050 may be electrically interfaced with the x-axis drive system motor leads 322, the y-axis drive system motor leads 522, the z-axis drive system motor leads 572, the x-axis drive system limit switches 400, 402 and the y-axis drive system limit switches 600, 602. Additionally, the animated display 100 may be provided with a speaker 1060, memory 1070 and a power supply (not shown). The speaker 1060 and memory 1070 may be electrically interfaced with the controller 1050. Preprogrammed paths may be stored in the memory 1070. The controller 1050 may cause the x-axis, y-axis and z-axis drive systems 300, 500, 700 to move the figure 800 according to the preprogrammed paths stored in the memory 1070. Furthermore, the memory may contain music that can be played through the speaker 1060.

With reference to FIG. 17 illustrating the animated display 100 with a rectangle image 1100 formed thereon, the process of forming the image 1100 will now be provided. The rectangle image 1100 may be provided with a top line 1102, a bottom line 1104, a left line 1106 and a right line 1108. These lines 1102, 1104, 1106 and 1108 may intersect each other at corners 1110, 1112, 1114 and 1116 as illustrated in FIG. 17.

Having described the rectangle image 1100, the process of forming the image will now be provided. At the outset, figure 800 may be located at a ‘home’ position wherein the gantry 630 is located near the left side 186 of the billboard 180 and the figure 800 is located near the housing top 120. Upon receipt of a start command (such as by pushing a button, not shown), one of the preprogrammed paths stored in memory 1070 may be accessed. This preprogrammed path contains machine operable instructions for moving the figure 800 via the x-axis, y-axis and z-axis drive systems 300, 500, 700, respectively. For example the preprogrammed path may cause the figure 800 to move in the +y direction and in the +x direction via the y-axis and x-axis drive systems 300, 500, respectively. Once the magnet 870 held by the figure 800 overlays the first corner 1110 of the rectangle image 1100, the z-axis drive system 700 may be activated to bring the magnet 870 into contact with the external surface 256 of the writing panel front 232. By contacting the magnet 870 to the external surface 256, the particles 272 suspended in the liquid 270 are pulled to the writing panel front internal surface 254. These particles 272 are pulled to the internal surface 254 and become viable as writing on the front 232 because the front 232 is translucent. This process of pulling particles may sometimes be referred to herein as selectively interfacing. Additionally, these pulled particles 272 remain at this location until a second magnetic force is applied thereto to pull them away from the front 232. To draw the top line 1102, the x-axis drive system 300 may be activated to move the figure 800 in the +x direction. This process of moving the figure 800 in the +x direction may occur by activating the motor 320 of the x-axis drive system 300 via the controller 1050 and the leads 322. The controller 1050 may count the number of graduations 341 on the disk 340 via the gate 360 and the leads 372. This process may be referred to herein as monitoring switch conditions of the gate 360. As the figure 800 moves in the +x direction, the magnet 870 pulls particles 272 suspended in the liquid 270 to the front 230 (thereby creating the top line 1102). Once the magnet 870 reaches the second corner 1112, the x-axis drive system 300 may be deactivated and the y-axis drive system 500 may be activated. The activation of the y-axis drive system 500 may move the magnet 870 in the −y direction according the selected preprogrammed path stored in the memory 1070. By counting the graduations 541 formed in disk 540, FIG. 11, the movement of the magnet 870 can be monitored by the controller 1050. Once the magnet 870 reaches the third corner, the right line 1108 has been drawn. With the magnet 870 at the third corner 1108, the bottom line 1104 may be drawn in a similar manner as drawing the top line 1102 except that the motor output shaft 326 may rotate in an opposite direction. After reaching the fourth corner 1116, the bottom line 1104 has been drawing and the left line 1106 can be drawn. After the left line 1106 has been drawn and the magnet 870 is located at the first corner 1110, the magnet 870 can be lifted from the front 232 by activating the z-axis drive system 700.

After drawing the rectangle image 1100, the figure 800 may be returned to the home position. If the writing panel 230 is to be erased, the eraser 900 may be used to move particles 272 away from the front 232. This utilization of the eraser 900 may occur by moving the lever 840 of the figure base 810 between the front 142 and the back 144 of the front slot 140. When moving the figure base lever 840 into the front slot 140, the first end 842 of the figure base 810 may contact the contact patch 1010 of the eraser actuator 1000. By contacting the eraser actuator 1000, the protrusion 1014 formed on the eraser actuator 1000 may be placed into a position where it can interface with the catch 960 formed on the eraser 900. With the eraser actuator 1000 interfaced with the eraser 900 (via the eraser actuator protrusion 1014 and the eraser catch 960), movement of the carriage 450 causes movement of the eraser 900. Therefore, with the eraser 900 interfaced with the carriage 450, the x-axis drive system 300 may be activated to move the eraser 900 in the +x direction. As the eraser 900 moves in the +x direction, the magnet 950 of the eraser 900 pulls particles 272 suspended in the liquid 270 to the back 234 of the writing panel 230. This movement of the particles 272 results in the erasure of writing found on the front 232 of the writing panel 230 (e.g. rectangle image 1100). After the eraser 900 has been moved in the +x direction across the entire area of the writing panel 230, the x-axis drive system 300 may be reversed (such as by reversing polarity of current applied to the leads 322) to move the eraser 900 in the −x direction. The eraser 900 may be returned to its home position and held therein by the retaining latch 970. In order to disengage the eraser 900 from the carriage 450, the figure base lever 840 may be moved out of contact with the eraser actuator 1000 via the y-axis drive system 500.

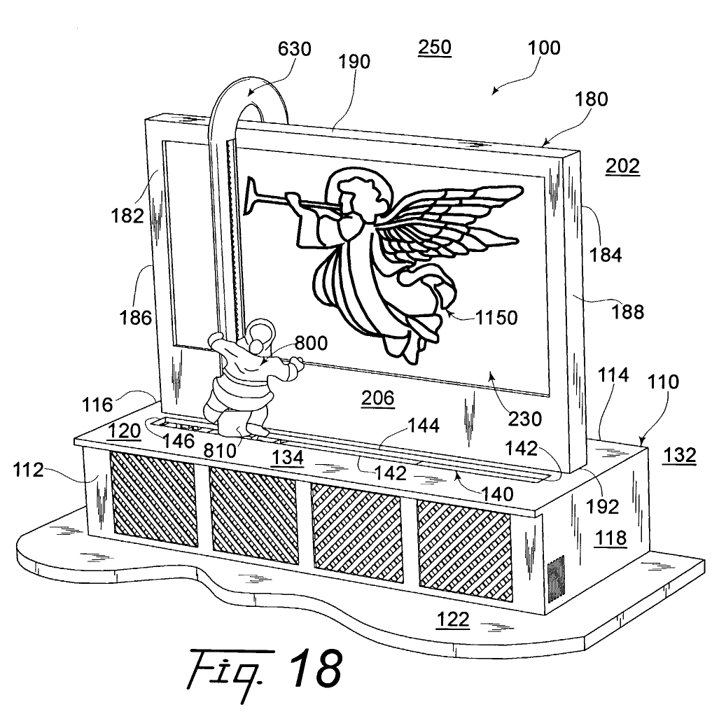

Having erased the writing panel 230, the process of drawing another image thereon may be completed. With reference to FIG. 18, an angel image 1150 may be formed on the writing panel 230 by the figure 800 (via the magnet 870, controller 1050, memory 1070 and drive systems 300, 500, 700). This process of forming the angel image 1150 may be substantially similar to the previously described formation of the rectangle image 1100. If an image (e.g. angel image 1150) requires that arcs, circles or non-orthogonal lines be formed, the x-axis and y-axis drive systems 300, 500 may be driven at the same time. This simultaneous driving of the drive systems 300, 500 may allow for these arcs, circles and non-orthogonal lines to be formed.

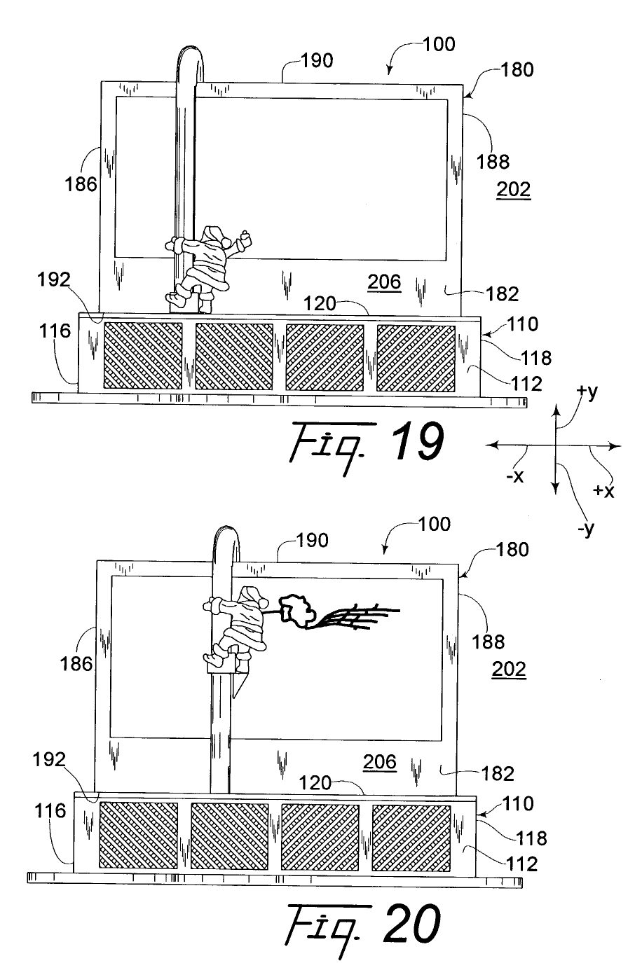

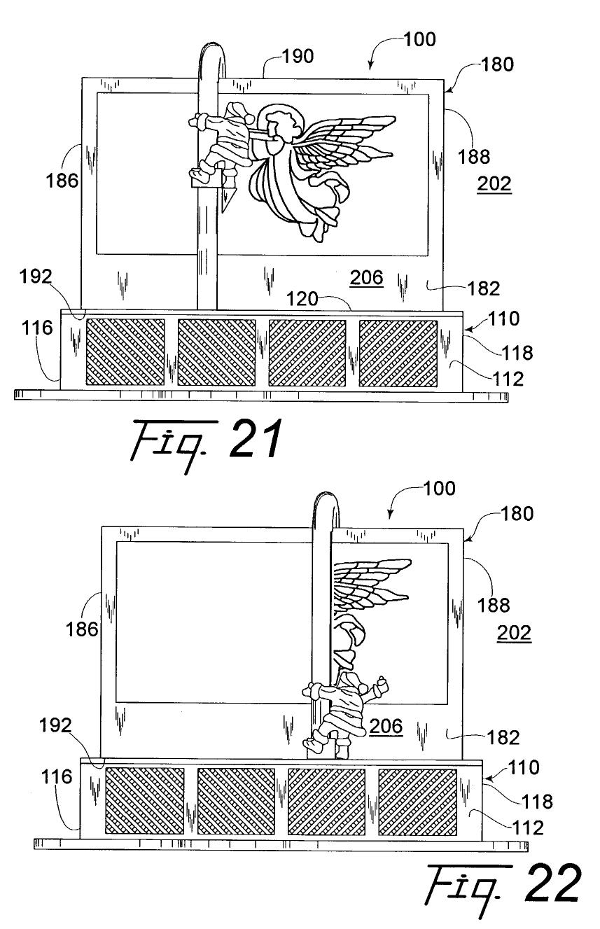

The process of forming the angel image 1150 may begin with an erased writing panel 230 as illustrated in FIG. 19. The figure 800 may begin to move about writing panel 230 of the animated display 100 as illustrated in FIGS. 20 and 21. After the angel image 1150 is complete, the animated display 100 may remain as depicted in FIG. 18, or, alternatively, the angel image 1150 nay be erased as illustrated in FIG. 22. After erasing the angel image 1150, other images preprogrammed into the animated display 100 (i.e. stored in the memory 1070) may be created in a similar manner.

Various alternative embodiments have been contemplated by the inventor. As described above, the figure 800 may take other forms such as, for example, a skier, a surfer, a skateboarder, an airplane, a boat, a witch on a broomstick, a ghost, a vampire, a dog, a puppy, a cat, a cow, a pig, a racecar, a tractor, a bus, or any one of a limitless number of other objects. The images formed on the writing panel 230 may be any of a limitless number of images depending on design intent.

While illustrative embodiments have been described in detail herein, it is to be understood that the concepts may be otherwise variously embodied and employed and that the appended claims are intended to be construed to include such variations except insofar as limited by the prior art.

I claim:

1. An erasable animated display comprising:
a writing panel comprising a first surface and an oppositely disposed second surface;
a magnet selectively interfaced with said first surface;
a first axis drive system attached to said first magnet;
a preprogrammed path; and
wherein said magnet is registered to said preprogrammed path by said first-axis drive system.

2. The display of claim 1 and further comprising:
a carriage attached to said first-axis drive system; and
wherein said magnet is attached to said carriage.

3. The display of claim 2 and further comprising:
a second-axis drive system formed on said carriage; and
wherein said magnet is attached to said carriage with said second-axis drive system.

4. The display of claim 3 and further comprising:
a third-axis drive system formed on said carriage; and
wherein said magnet is selectively interfaced with said first surface with said third axis drive system.

5. The display of claim 1 and further comprising:
a second magnet adjacent to a portion of said second surface; and
wherein, said second magnet is selectively attached to said first-axis drive system.

6. The display of claim 5 wherein said second magnet is a strip magnet.

7. The display of claim 5 and further comprising:
an actuator formed on said carriage, wherein said actuator selectably couples said second magnet to said first-axis drive system.

8. The display of claim 1 and further comprising:
a liquid disposed within said writing panel; and
ferrous particles suspended in said liquid.

9. The display of claim 1, wherein:
said display comprises a first condition and a second condition;
wherein, in said first condition, said magnet is magnetically engaged with said writing panel; and
wherein, in said second condition said magnet is magnetically disengaged from said writable layer.

10. The display of claim 1 and further comprising:
a controller;
a memory addressable by said controller; and
wherein said controller is electrically interfaced with said first-axis drive system.

11. A method of producing an image on a display, said method comprising:
providing a said display comprising a first surface and an oppositely disposed second surface;
providing a liquid with ferrous particles suspended therein, said liquid located between said first and second surfaces;
moving, according to a preprogrammed path, a first magnet adjacent to said first surface; and
selectively attracting said ferrous particles to said first surface.

12. The method of claim 11 and further comprising:
providing a second magnet;
erasing said display with said second magnet;
wherein said erasing said display comprises moving said second magnet adjacent to said second surface.

13. The method of claim 11 wherein said moving said first magnet comprises moving said first magnet in a first direction and a second direction.

14. The method of claim 13 wherein said preprogrammed path comprises a plurality of switch conditions.
